(19) United States
(12) Patent Application Publication
(10) Pub. No.: US 2024/0327221 A1
(43) Pub. Date: Oct. 3, 2024

(54) METHOD FOR MANUFACTURING POROUS CARBON SHEET AND POROUS CARBON SHEET

(71) Applicants: Nobuyuki NISHI, Ishikawa (JP); TOYOTA BOSHOKU KABUSHIKI KAISHA, Aichi-ken (JP); AICHI UNIVERSITY OF EDUCATION, Aichi (JP)

(72) Inventors: Junko OHIRA, Kariya-shi (JP); Masaaki TAKEMOTO, Kariya-shi (JP); Shigetomi HONDA, Kariya-shi (JP); Kazuyuki HINO, Nagoya-shi (JP); Nobuyuki NISHI, Kanazawa-shi (JP)

(73) Assignees: Nobuyuki NISHI, Ishikawa (JP); TOYOTA BOSHOKU KABUSHIKI KAISHA, Aichi-ken (JP); AICHI UNIVERSITY OF EDUCATION, Aichi (JP)

(21) Appl. No.: 18/614,930

(22) Filed: Mar. 25, 2024

(30) Foreign Application Priority Data
Mar. 28, 2023 (JP) 2023-052311

(51) Int. Cl. C01B 32/184

(52) U.S. Cl. CPC C01B 32/184; C01P 2002/01; C01P 2004/03; C01P 2004/04; C01P 2004/20; C01P 2004/62; C01P 2006/16

(57) ABSTRACT

A method for manufacturing a porous carbon sheet includes agitating a solution containing copper methylacetylide as a precursor to form wire-shaped structures of the precursor and entangle the wire-shaped structures in the solution, forming the precursor into a sheet-shaped precursor, and calcining the sheet-shaped precursor in a range of 1000° C. to 1200° C. to grow multilayer cavity walls of graphene and thermally remove copper so as to form the porous carbon sheet.

### BACKGROUND

### 1. Field

The present disclosure relates to a method for manufacturing a porous carbon sheet and a porous carbon sheet.

### 2. Description of Related Art

Japanese Laid-Open Patent Publication No. 2014-86305 discloses a method for manufacturing a porous carbon sheet. In the manufacturing method described in this publication, first, methylacetylene gas is sprayed to an aqueous ammonia containing cuprous chloride while agitating the aqueous ammonia, so as to obtain a precipitate of wire-shaped crystals of copper methylacetylide. Next, the precipitate is filtered off with a filter and heated under reduced pressure to obtain a black flocculent solid. Next, a nitric acid aqueous solution is added to the solid to dissolve copper. The solid is filtered off, washed and dried, and then heated in a quartz tube at 1100° C. for twelve hours under vacuum. As a result, an organic thin film is deposited on and copper is sublimated and deposited on the inner wall of the end of the quartz tube. Only the carbon components are removed from the deposit and the residual copper is dissolved again with hot nitric acid. This is dried and then placed in an alumina Tammann tube and heated at 1400° C. for ten hours so as to obtain a porous carbon material having a graphene layer. Then, a solution obtained by dissolving the porous carbon material, potassium permanganate, and sulfuric acid in ultrapure water is refluxed while applying ultrasonic vibration to the solution. Thereafter, the solid obtained by filtration of the solution is heat-treated at 250° C. for three hours to obtain porous carbon carrying a manganese oxide and having a graphene layer. Then, the porous carbon and PTFE as a binder are dissolved in ethanol and kneaded to obtain a paste-like ink. The ink is rolled to obtain sheet-shaped porous carbon.

The manufacturing method disclosed in the above publication requires a relatively large number of manufacturing steps for manufacturing the porous carbon sheet, and takes relatively long time for manufacture.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method for manufacturing a porous carbon sheet is provided. The porous carbon sheet is composed of multilayer cavity walls of graphene, has mesoporosity, and includes a structure in which hollow wire-shaped crystals are entangled. The method includes agitating a solution containing copper methylacetylide as a precursor to form wire-shaped structures of the precursor and entangle the wire-shaped structures in the solution, forming the precursor into a sheet-shaped precursor, and calcining the sheet-shaped precursor in a range of 1000° C. to 1200° C. to grow multilayer cavity walls of graphene and thermally remove copper so as to form the porous carbon sheet.

In another general aspect, a porous carbon sheet is composed of multilayer cavity walls of graphene and includes a structure in which hollow wire-shaped crystals having mesoporosity are entangled. Wire diameters of the crystals are in a range of 100 nm to 500 nm. Diameters of pores formed by the entangled crystals are in a range of 10 nm to 200 nm.

Other features and aspects will be apparent from the following detailed description, the drawings, and the claims.

### BRIEF DESCRIPTION OF THE DRAWINGS

FIG. 1 is an SEM image of a porous carbon sheet of one embodiment.

FIG. 2 is another SEM image of the porous carbon sheet of the embodiment.

FIG. 3 is an expanded SEM image of a part of the porous carbon sheet of the embodiment.

FIG. 4 is an expanded SEM image of another part of the porous carbon sheet of the embodiment.

FIG. 5 is a TEM image of the porous carbon sheet of the embodiment.

FIG. 6 is a TEM image of a precursor during a drying step of the embodiment.

FIG. 7 is a flowchart showing a procedure for manufacturing the porous carbon sheet according to the embodiment.

FIG. 8 is an SEM image of a porous carbon of a comparative example.

FIG. 9 is an expanded SEM image of the porous carbon of the comparative example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

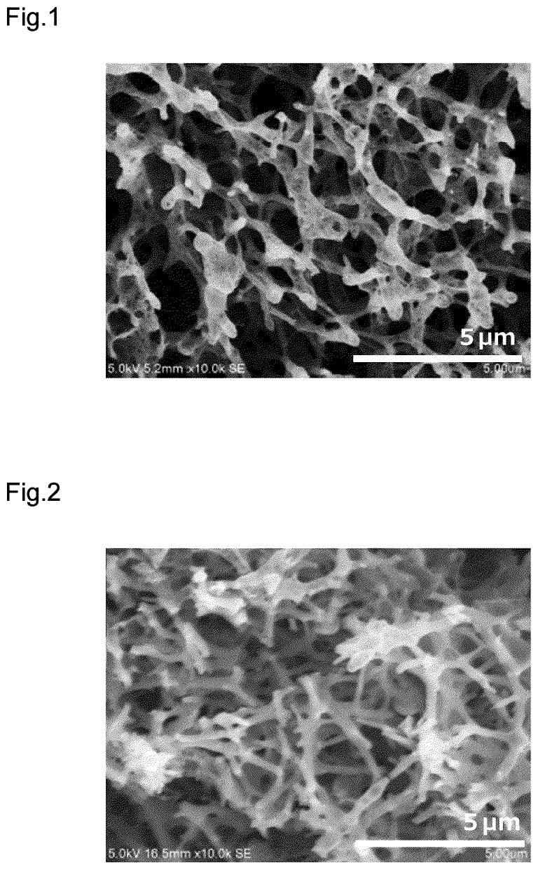

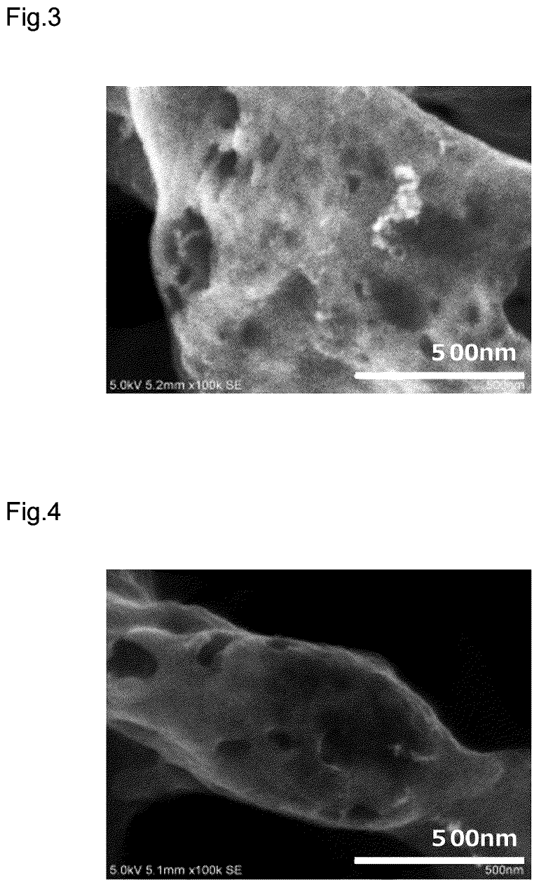

A method for manufacturing a porous carbon sheet and a porous carbon sheet according to one embodiment will now be described with reference to FIGS. 1 to 7.

As shown in FIGS. 1 to 4, the porous carbon sheet is composed of multilayer cavity walls of graphene and includes a structure in which hollow wire-shaped crystals having mesoporosity are entangled.

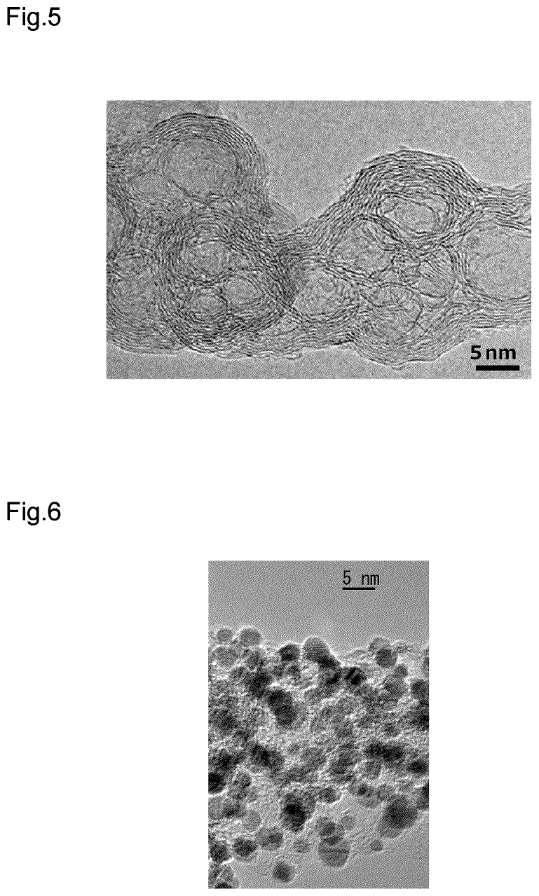

As shown in FIG. 5, the porous carbon sheet has a pore structure partitioned by multilayer cavity walls of graphene.

The wire diameters of the crystals are in a range of 100 nm to 500 nm. The diameters of pores formed by the entangled crystals are in a range of 10 nm to 200 nm.

The porous carbon sheet of the present embodiment can be used as, for example, a gas diffusion layer forming a single cell of a polymer electrolyte fuel cell.

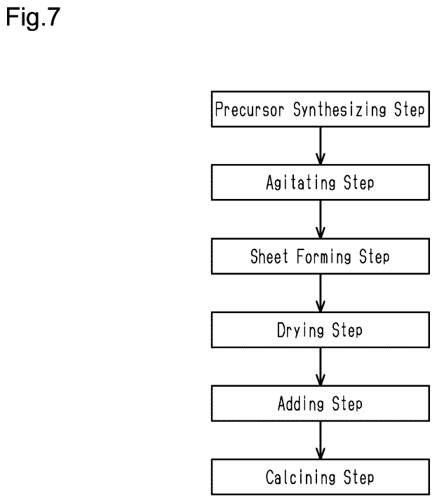

Next, a manufacturing procedure of the porous carbon sheet of the present embodiment will be described with reference to FIG. 7.

As shown in FIG. 7, the method for manufacturing a porous carbon sheet includes a precursor synthesizing step, an agitating step, a sheet forming step, a drying step, an adding step, and a calcining step.

The precursor synthesizing step is a step for synthesizing copper methylacetylide as a precursor by a known method.

The agitating step is a step for agitating a solution containing copper methylacetylide as a precursor to form wire-shaped structures, and to entangle the wire-shaped structures in the solution. Water is used as solvent. Adding a small amount of ethanol to the solvent facilitate stretching of the precursor.

In the agitating step, the wire-shaped structures of the precursor are formed by agitating the solution containing copper methylacetylide. At this time, in the subsequent heating step, the copper becomes spherical or elliptical due to the difference in specific gravity between copper and carbon, and the carbon becomes wires covering the copper. In addition, the wire-shaped structures of the precursor are entangled in the solution.

The sheet forming step is a step for forming the precursor into a sheet-shaped precursor.

In the sheet forming step, the wire-shaped structures of the precursor, which are entangled, are formed into a sheet-shaped precursor. Examples of the method for forming the wire-shaped structures of the precursor into a sheet-shaped precursor include a method of filtering a solution containing the precursor with filter paper to form a sheet on the filter paper, a method of applying the solution to a planar jig, and a method of spraying the solution onto a planar jig.

The drying step is a step for heating the sheet-shaped precursor to a temperature in a range of 170° C. to 300° C. under vacuum to dry the precursor. Accordingly, although phase separation of copper and carbon occurs, the shape of the precursor is readily maintained.

FIG. 6 shows the separation of copper and methylacetylene polymer during the heating process of the precursor to a temperature in a range of 60° C. to 200° C. in the drying step. Specifically, FIG. 6 shows how copper becomes spherical and methyl groups are released as methane and ethylene gas to the outside of the system.

The adding step is a step for adding a phenol resin to the sheet-shaped precursor. The precursor is preferably dried after the addition of the phenol resin.

The calcining step is a step for calcining the sheet-shaped precursor in a range of 1000° C. to 1200° C. to grow multilayer cavity walls of graphene and thermally remove copper so as to form a porous carbon sheet.

The calcining step is preferably performed under a pressure lower than normal pressure.

In the calcining step, copper is sublimated and removed by calcining the precursor in a range of 1000° C. to 1200° C. The copper in contact with a portion of the carbon of the precursor melts at a temperature higher than or equal to 1000° C. At this time, an ideal two-dimensional surface of carbon is generated due to surface tension generated in the carbon, so that the carbon grows into multilayer cavity walls of graphene. This forms a porous carbon sheet that is composed of multilayer cavity walls of graphene and includes a structure in which hollow wire-shaped crystals having mesoporosity are entangled.

The melting point of copper is 1085° C. However, in a case of particles of sizes less than or equal to 50 nm, liquefaction of copper proceeds at 1000° C. or less due to the depression of melting point.

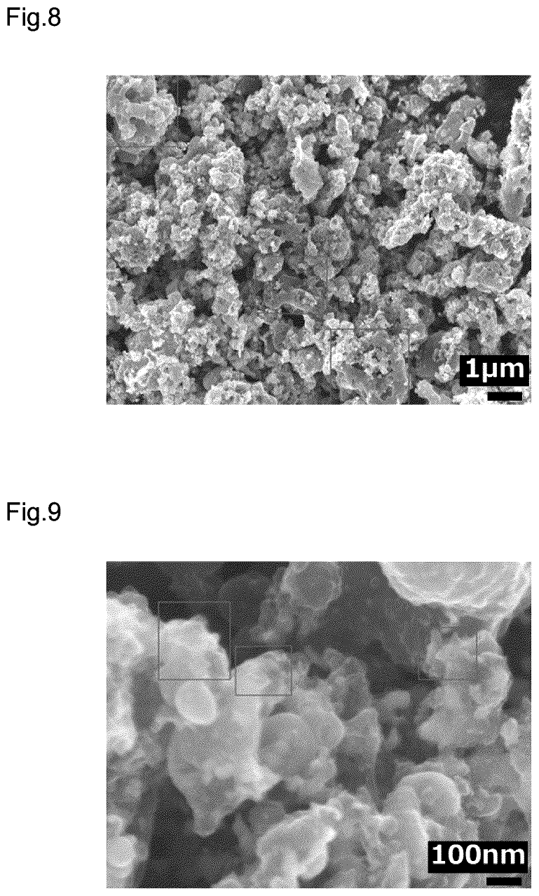

FIGS. 8 and 9 show SEM images of porous carbon of a comparative example. The porous carbon of the comparative example was formed by performing vacuum calcination while dropping the precursor of the present embodiment into a furnace without forming the precursor into a sheet-shaped precursor.

The present embodiment has the following advantages.

(1) The method for manufacturing a porous carbon sheet includes the agitating step, the sheet forming step, and the calcining step.

With this method, by calcining a sheet-shaped precursor of copper methylacetylide, the precursor is carbonized while maintaining the wire-shaped structures of the precursor. This eliminates the necessity for a step for forming a sheet by carbonizing a precursor and then pulverizing the precursor as in the prior art.

In addition, with the above-described method, since the calcining temperature is in a range of 1000° C. to 1200° C., the calcining temperature is lowered as compared with, for example, a conventional manufacturing method in which silver methylacetylide is calcined at 2000° C. This allows the size of the calcining furnace and the energy required for calcination to be reduced.

In addition, copper is preferable to silver in order to grow thick multilayer cavity walls of graphene so as to increase conductivity.

This facilitates the manufacture of the porous carbon sheet.

(2) The method further includes the adding step for adding a phenol resin to the sheet-shaped precursor before the calcining step.

With this configuration, since the rigidity of the precursor is increased by adding the phenol resin, the shape of the sheet-shaped precursor is readily maintained. This increases the yield rate of the porous carbon sheet.

(3) Since the calcining step is performed under a pressure lower than normal pressure, the growth of the graphene multilayer cavity walls and the thermal removal of copper can be performed at a low calcining temperature. This allows the size of the calcining furnace and the energy required for calcination to be reduced.

(4) Since the porous carbon sheet is composed of multilayer cavity walls of graphene and includes a structure in which hollow wire-shaped crystals having mesoporosity are entangled, the porous carbon sheet has a high conductivity. In addition, according to the above-described configuration, the wire diameters of the crystals are in a range of 100 nm to 500 nm, and the diameters of pores formed by the entangled crystals are in a range of 10 nm to 200 nm. The porous carbon sheet thus has a high gas permeability. Since water can be stored in and discharged from a great number of mesopores in the crystals, the porous carbon sheet is excellent in adjusting the water retention amount.

Therefore, the porous carbon sheet has a high conductivity and a high gas permeability, and is excellent in adjusting the water retention amount.

### Modifications

The above-described embodiment may be modified as follows. The above-described embodiment and the following modifications can be combined as long as the combined modifications remain technically consistent with each other.

The calcining step can also be performed under normal pressure.

The adding step of adding the phenol resin may be omitted.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A method for manufacturing a porous carbon sheet that is composed of multilayer cavity walls of graphene, has mesoporosity, and includes a structure in which hollow wire-shaped crystals are entangled, the method comprising:
agitating a solution containing copper methylacetylide as a precursor to form wire-shaped structures of the precursor and entangle the wire-shaped structures in the solution;
forming the precursor into a sheet-shaped precursor; and
calcining the sheet-shaped precursor in a range of 1000° C. to 1200° C. to grow multilayer cavity walls of graphene and thermally remove copper so as to form the porous carbon sheet.

2. The method for manufacturing a porous carbon sheet according to claim 1, further comprising adding a phenol resin to the sheet-shaped precursor before calcining the precursor.

3. The method for manufacturing a porous carbon sheet according to claim 1, wherein the precursor is calcined under a pressure lower than a normal pressure.

4. A porous carbon sheet that is composed of multilayer cavity walls of graphene and includes a structure in which hollow wire-shaped crystals having mesoporosity are entangled, wherein
wire diameters of the crystals are in a range of 100 nm to 500 nm, and
diameters of pores formed by the entangled crystals are in a range of 10 nm to 200 nm.
